(19) United States
(12) Patent Application Publication
(10) Pub. No.: US 2022/0398116 A1
(43) Pub. Date: Dec. 15, 2022

(54) Application Virtualization System

(71) Applicant: Citrix Systems, Inc., Fort Lauderdale, FL (US)

(72) Inventors: Ze Chen, Nanjing (CN); Xiao Zhang, Nanjing (CN)

(21) Appl. No.: 17/375,160

(22) Filed: Jul. 14, 2021

Related U.S. Application Data
(63) Continuation of application No. PCT/CN21/99994, filed on Jun. 15, 2021.

(51) Int. Cl. G06F 9/455; G06F 9/451

(52) U.S. Cl. CPC G06F 9/45558; G06F 9/452; G06F 2009/4557; G06F 2009/45595

(57) ABSTRACT

Methods and systems for application virtualization are described herein. The system may provide a plurality of endpoint devices with access to an application. The application may be hosted by a computing device and configured to run on a mobile computing device. The computing device may determine instructions to execute the application for different endpoint devices of the plurality based on information about the plurality of endpoint devices. The computing device may modify output from execution of the determined instructions into graphics data and may provide the graphics data to at least one of the plurality of endpoint devices to enable that endpoint device to render a user interface in which to access the application.

### CROSS-REFERENCE TO RELATED APPLICATION

This application is a continuation of PCT Application No. PCT/CN2021/099994, filed on Jun. 15, 2021, and entitled “Application Virtualization System”. The above-mentioned application is incorporated herein by reference in its entirety and for all purposes.

### FIELD

Aspects described herein generally relate to computer networking, remote computer access, virtualization, enterprise mobility management, and hardware and software related thereto. More specifically, one or more aspects described herein provide systems and methods for the deployment of applications on mobile endpoint devices.

### BACKGROUND

Device virtualization gives users the flexibility to work remotely when needed, centralize hardware in a cloud, and access applications and virtualized desktops remotely. Using virtualization technology, a user may access, via a user interface on a user device, applications executed on a remote computing device. An improved system is needed to support the virtualization of applications with a variety of functions and operating on a variety of devices.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

Virtualizing applications configured to run on mobile devices may present challenges since device virtualization does not account for special needs and hardware with respect to mobile devices, and therefore does not work as well with or on mobile devices as it does with conventional desktop and laptop computers. When a mobile application is downloaded and used on a computing device, virtualized applications and desktops do not properly account for mobile-specific features such as GPS, SIM data, and pressure-sensitive touch input. In addition, mobile devices have non-uniform compact form factors, and provide haptic feedback in addition to audiovisual output. With these different form factors, input techniques, and output types, virtualization that has historically been driven by desktop computing does not work as it should when virtualizing mobile devices.

To overcome limitations described above, and to overcome other limitations that will be apparent upon reading and understanding the present specification, aspects described herein are directed towards systems and methods for application virtualization on remote servers, and more specifically provides techniques for improved virtualization of mobile devices.

In one or more illustrative embodiments, a computing device may provide a plurality of endpoint devices with access to an application, the application being hosted by the computing device and configured to run on a mobile computing device. The computing device may determine instructions to execute the application for different endpoint devices of the plurality based on information about the plurality of endpoint devices. The computing device may modify output from execution of the determined instructions into graphics data, and may provide the graphics data to at least one of the plurality of endpoint devices to enable that endpoint device to render a user interface in which to access the application.

In one or more instances, the information about the plurality of endpoint devices comprises at least one of: current location of the different endpoint devices of the plurality; or current Internet Protocol (IP) address of the different endpoint devices of the plurality.

In one or more instances, the information about the plurality of endpoint devices may comprise a subscriber identification module (SIM) data associated with a first endpoint device of the plurality. An execution of the application requires access to a mobile communication network. The SIM data is used to access the mobile communication network. The first endpoint device is in a geographical location outside a service area of the mobile communication network. The computing device may deploy an instance on a first computing component within the service area of the mobile communication network, and communicate, by the first computing component and using the SIM data, with the mobile communication network.

In one or more instances, the computing device may obtain a preferred list that indicates the application is preferred to be executed on a first operating system, and deploy, based on the preferred list, a plurality of instances on a computing component running on the first operating system to execute of the application.

In one or more instances, the computing component is a virtual machine. Deploying the one or more instances on a computing component further comprises creating, based on the preferred list, the virtual machine, and deploying the one or more instances on the virtual machine. The computing device may assign, to the computing component, a virtual address, and establish, using the virtual address, a plurality of channels between the plurality of endpoint devices and the computing component.

In one or more instances, the computing device may obtain a first performance parameter associated with executing the application on the first operating system, obtain a second performance parameter associated with executing the application on a second operating system, and generate, based on the first performance parameter is superior to the second performance parameter, the preferred list. The first performance parameter comprises stability associated with the execution of the application or speed associated with the execution of the application.

In one or more instances, the plurality of channels may comprise a first channel configured to transmit data associated with a native resource on a first endpoint device of the plurality. The computing device may determine an execution of a first instance of the plurality of instances, during a time period, does not require accessing the native resource, and disable, based on the determination, the first channel.

In one or more illustrative embodiments, a desktop computing device may send, to a server, a request associated with a first application being hosted by the server and configured to run on a mobile computing device. The desktop computing device may receive graphics data associated with the first application and receive a preferred display parameter associated with the first application. The desktop computing device may present, on a graphical user interface and based on the preferred display parameter, a first output window. The graphics data is displayed in the first output window. The desktop computing device may determine a vacant space on the graphical user interface, and present, on the graphical user interface, a second output window associated with a second application.

In one or more instances, a preferred display parameter comprises a minimum preferred size. The desktop computing device may receive, a command to present a third output window, determine the minimum preferred size is smaller than a current size of the first output window, resize, based on the determination, the first output window, and display the first output window on a first portion of the graphical user interface and the third output window on a second portion of the graphical user interface. The graphical user interface is a landscape orientation, and wherein the preferred display parameter comprises a portrait orientation.

In one or more instances, one or more channels between the desktop computing device and the server may be established. The one or more channels may comprise a first channel configured to transmit data associated with a native resource on the desktop computing device. The desktop computing device may determine execution of the first application does not require, during a time period, the native resource, and disable, based on the determination, the first channel.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts a virtualized system architecture that may be used in accordance with one or more illustrative aspects described herein.

FIG. 4 depicts a cloud-based system architecture that may be used in accordance with one or more illustrative aspects described herein.

FIG. 5A is a block diagram of an example system in which resource management services may manage and streamline access by clients to resource feeds (via one or more gateway services) and/or software-as-a-service (SaaS) applications.

FIG. 5B is a block diagram showing an example implementation of the system shown in FIG. 5A in which various resource management services as well as a gateway service are located within a cloud computing environment.

FIG. 5C is a block diagram similar to that shown in FIG. 5B but in which the available resources are represented by a single box labeled “systems of record,” and further in which several different services are included among the resource management services.

FIG. 5D shows how a display screen may appear when an intelligent activity feed feature of a multi-resource management system, such as that shown in FIG. 5C, is employed.

FIG. 6 depicts an illustrative enterprise mobility management system.

FIG. 7 depicts another illustrative enterprise mobility management system.

FIG. 8 depicts an example of an illustrative computing environment that may implement application virtualization in accordance with one or more illustrative aspects described herein.

FIG. 9 depicts another example of an illustrative computing environment that may implement application virtualization in accordance with one or more illustrative aspects described herein.

FIG. 10 depicts a flow diagram of an example method for application virtualization in accordance with one or more illustrative aspects described herein.

FIG. 11 depicts a flow diagram of another example method for application virtualization in accordance with one or more illustrative aspects described herein.

FIG. 12A and FIG. 12B depict example information in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” “positioned,” and similar terms, is meant to include both direct and indirect connecting, coupling, and positioning.

Computing Architecture

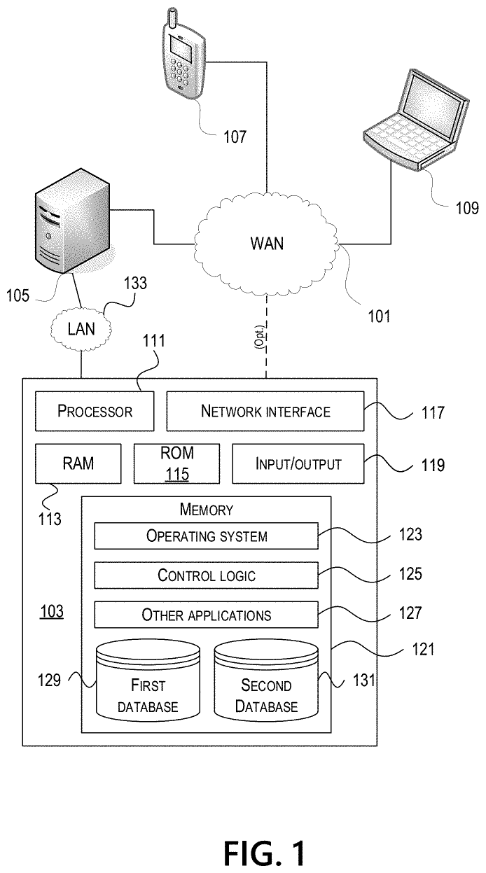

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

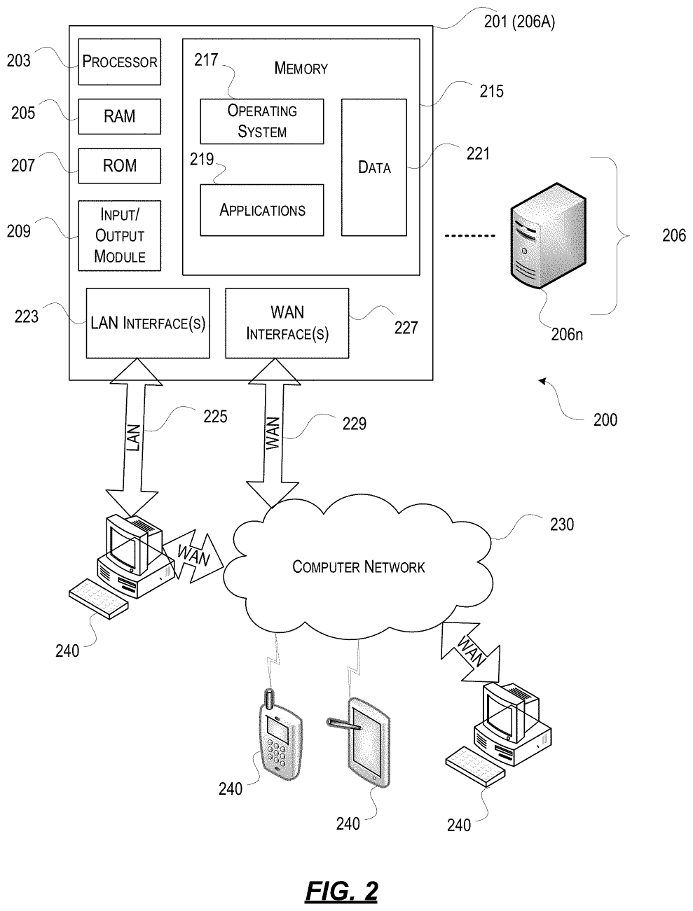

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an output window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

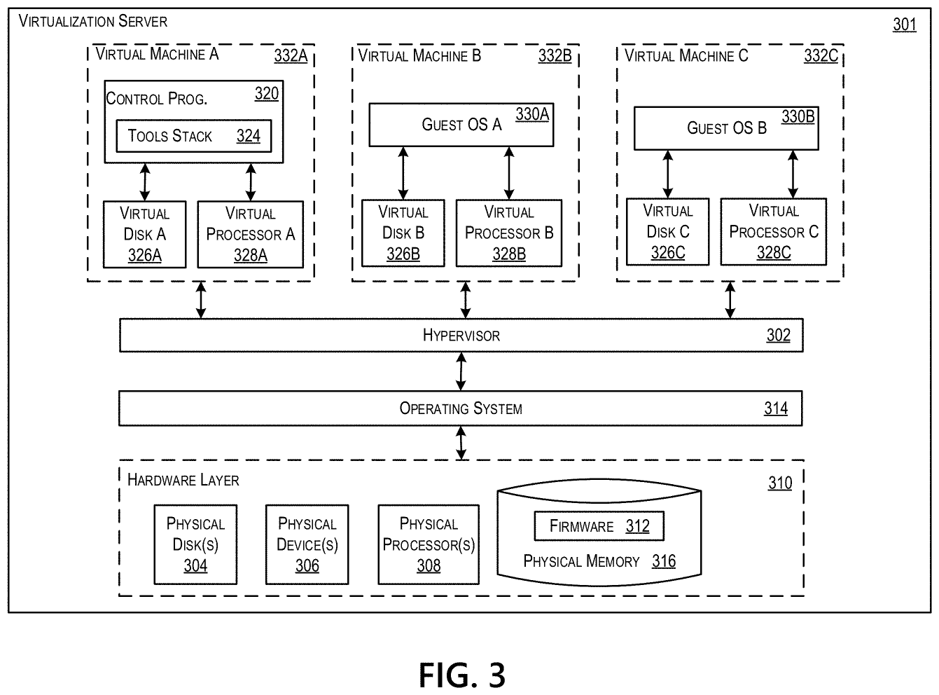

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing component. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same parameters of at least one physical processor 308. In other embodiments, virtual processor 308 provides a modified view of physical processors 308 such that at least some of the parameters of the virtual processor 328 are different than the parameters of the corresponding physical processor 308.

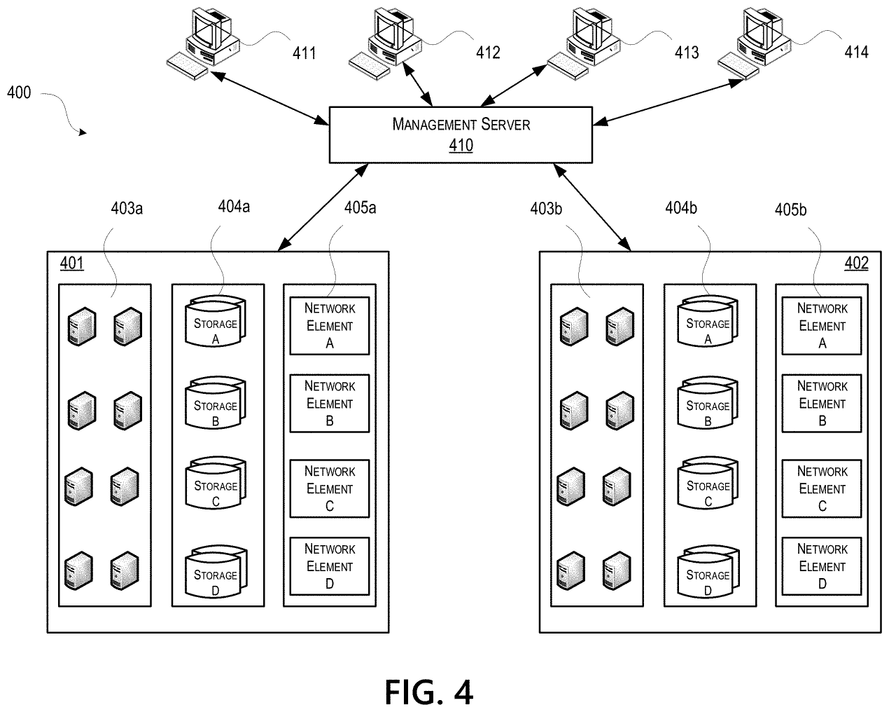

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Resource Management System

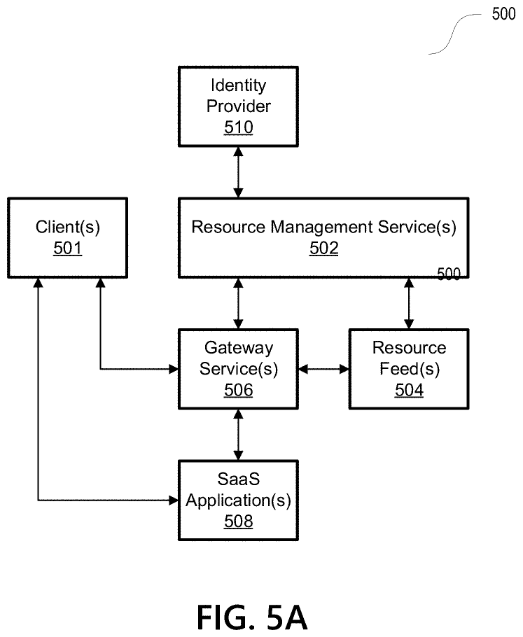

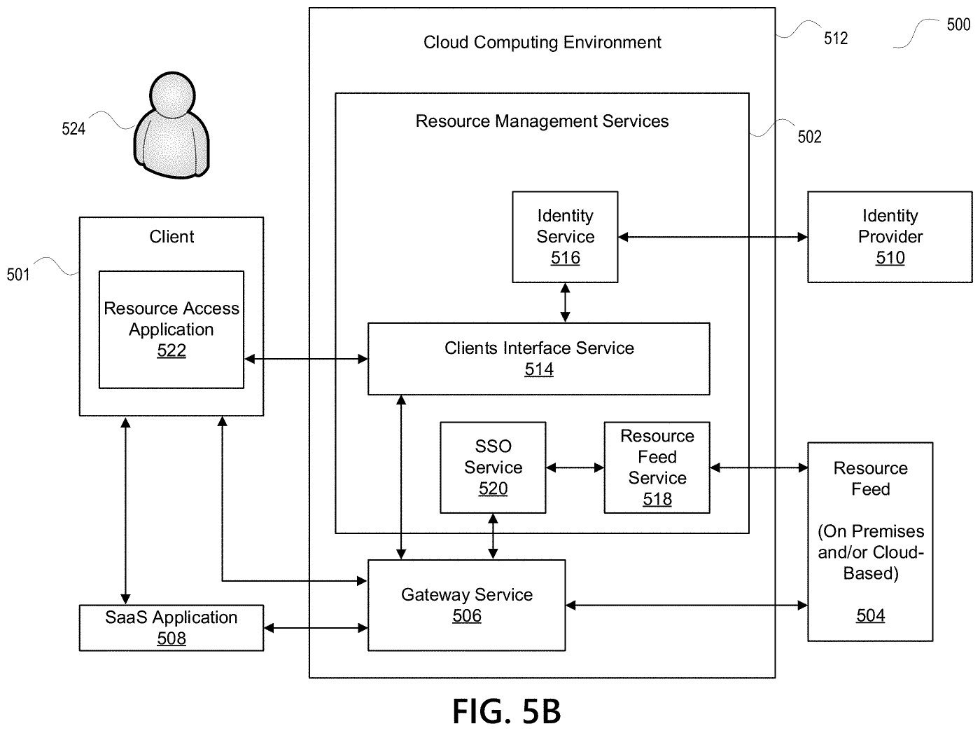

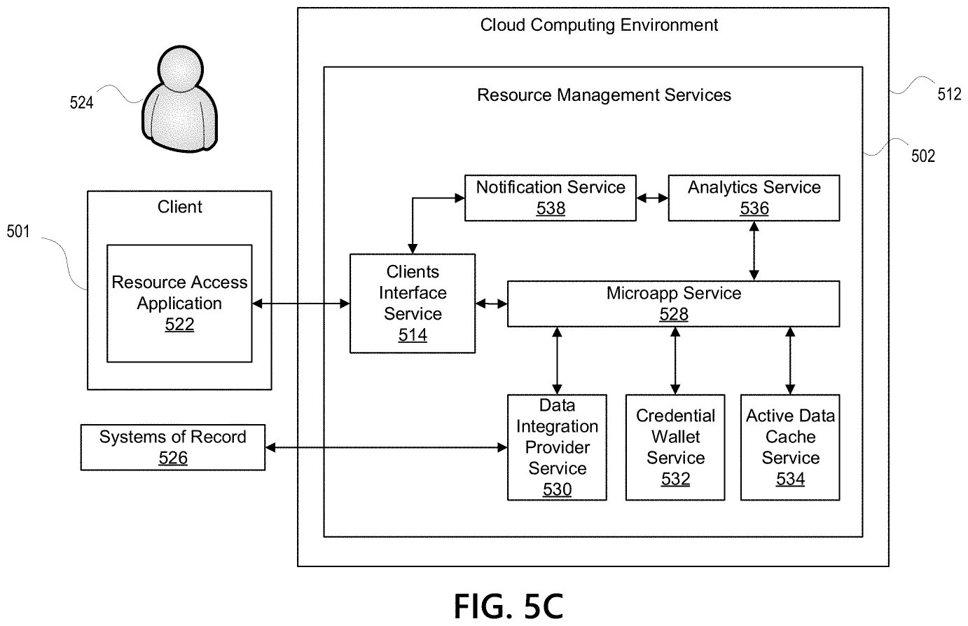

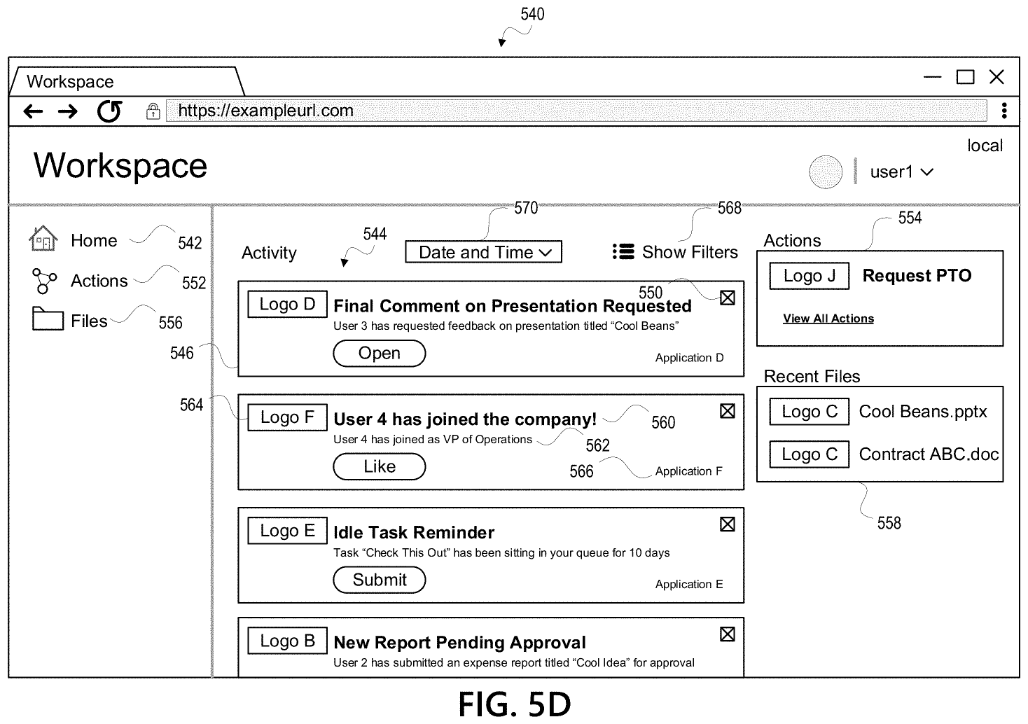

FIG. 5A is a block diagram of an example multi-resource access system 500 in which one or more resource management services 502 may manage and streamline access by one or more clients 501 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 501 and, following authentication, identify one of more resources the user is authorized to access. In response to the user selecting one of the identified resources, the resource management service(s) 502 may send appropriate access credentials to the requesting client 501, and the client 501 may then use those credentials to access the selected resource. For the resource feed(s) 504, the client 501 may use the supplied credentials to access the selected resource via a gateway service 506. For the SaaS application(s) 508, the client 501 may use the credentials to access the selected application directly.

The client(s) 501 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 501, one or more file repositories and/or file sharing systems, one or more secure browser services, one or more access control services for the SaaS applications 508, one or more management services for local applications on the client(s) 501, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 501) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 501 may use a resource access application 522 to communicate with the client interface service 514 as well as to present a user interface on the client 501 that a user 524 can operate to access the resource feed(s) 504 and/or the SaaS application(s) 508. The resource access application 522 may either be installed on the client 501, or may be executed by the client interface service 514 (or elsewhere in the multi-resource access system 500) and accessed using a web browser (not shown in FIG. 5B) on the client 501.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., user-name and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 501 to be redirected to the cloud-based identity service to complete an authentication process. The cloud-based identity service may then cause the client 501 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 501. The list of available resources may, for example, be presented on the user interface of the client 501 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 501, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 501 may proceed to access the selected resource.

When the user 524 selects a local application, the resource access application 522 may cause the selected local application to launch on the client 501. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 501 may then launch the identified browser and initiate a connection to the gateway service 506. The gateway service 506 may then request an assertion from the single sign-on service 520. Upon receiving the assertion, the gateway service 506 may cause the identified browser on the client 501 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 501 to access the selected SaaS application 508.

In some embodiments, the preferred browser identified by the gateway service 506 may be a specialized browser embedded in the resource access application 522 (when the resource access application 522 is installed on the client 501) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 501 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 501, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 501 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 501. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically cause active data to be pulled from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 501 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 501 as a push notification to the user 524.

In some embodiments, a process for processing a user-initiated action via a microapp may operate as follows. The client 501 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce®, Ariba®, Concur®, RightSignature®, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system or record to which the notification 546 corresponds, thus helping the user understand the proper context with which to decide how best to respond to the notification 546. In some implementations, one of more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D) and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user-interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp. In addition to the event-driven actions accessible via the action elements 548 in the notifications 546, a user may alternatively initiate microapp actions by selecting a desired action, e.g., via a drop-down menu accessible using the “action” user-interface element 552 or by selecting a desired action from a list 554 of recently and/or commonly used microapp actions. As shown, the user may also access files (e.g., via a Citrix ShareFile™ platform) by selecting a desired file, e.g., via a drop-down menu accessible using the “files” user interface element 556 or by selecting a desired file from a list 558 of recently and/or commonly used files.

Although not shown in FIG. 5D, it should be appreciated that, in some implementations, additional resources may also be accessed through the screen 540 by clicking on or otherwise selecting one or more other user interface elements that may be presented on the screen. For example, in some embodiments, one or more virtualized applications may be accessible (e.g., via a Citrix Virtual Apps and Desktops™ service) by clicking on or otherwise selecting an “apps” user-interface element (not shown) to reveal a list of accessible applications and/or one or more virtualized desktops may be accessed (e.g., via a Citrix Virtual Apps and Desktops® service) by clicking on or otherwise selecting a “desktops” user-interface element (not shown) to reveal a list of accessible desktops.

The activity feed shown in FIG. 5D provides significant benefits, as it allows a user to respond to application-specific events generated by disparate systems of record without needing to navigate to, launch, and interface with multiple different native applications.

Enterprise Mobility Management Architecture

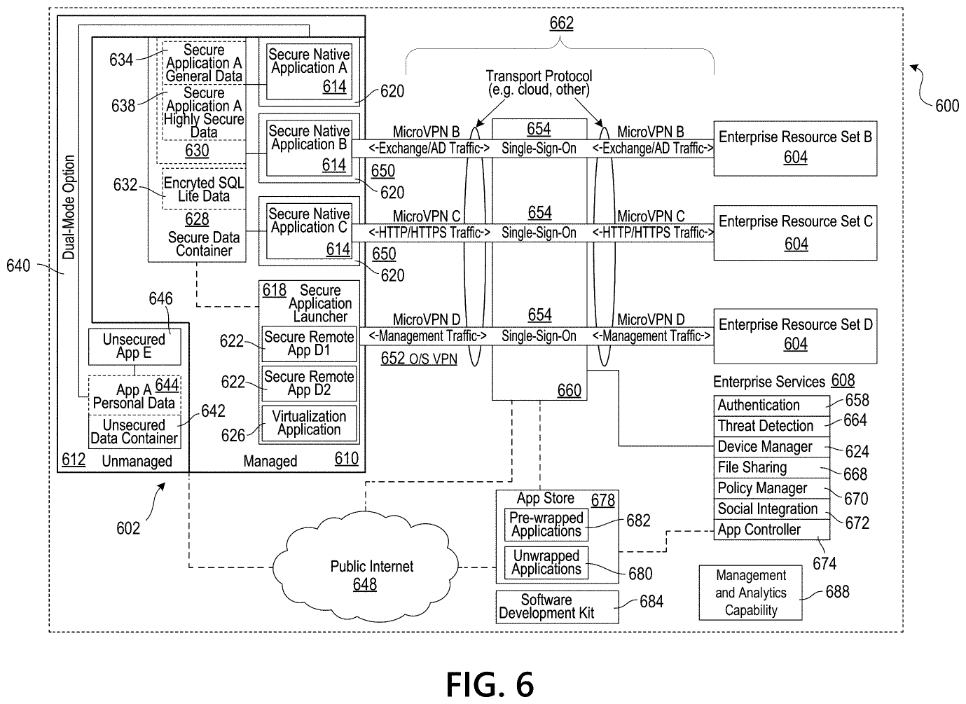

FIG. 6 represents an enterprise mobility technical architecture 600 for use in a “Bring Your Own Device” (BYOD) environment. The architecture enables a user of a mobile device 602 to both access enterprise or personal resources from a mobile device 602 and use the mobile device 602 for personal use. The user may access such enterprise resources 604 or enterprise services 608 using a mobile device 602 that is purchased by the user or a mobile device 602 that is provided by the enterprise to the user. The user may utilize the mobile device 602 for business use only or for business and personal use. The mobile device 602 may run an iOS operating system, an Android operating system, or the like. The enterprise may choose to implement policies to manage the mobile device 602. The policies may be implemented through a firewall or gateway in such a way that the mobile device 602 may be identified, secured or security verified, and provided selective or full access to the enterprise resources (e.g., 604 and 608.) The policies may be mobile device management policies, mobile application management policies, mobile data management policies, or some combination of mobile device, application, and data management policies. A mobile device 602 that is managed through the application of mobile device management policies may be referred to as an enrolled device.

In some embodiments, the operating system of the mobile device 602 may be separated into a managed partition 610 and an unmanaged partition 612. The managed partition 610 may have policies applied to it to secure the applications running on and data stored in the managed partition 610. The applications running on the managed partition 610 may be secure applications. In other embodiments, all applications may execute in accordance with a set of one or more policy files received separate from the application, and which define one or more security parameters, features, resource restrictions, and/or other access controls that are enforced by the mobile device management system when that application is executing on the mobile device 602. By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple applications as described herein (virtual partition). Stated differently, by enforcing policies on managed applications, those applications may be restricted to only be able to communicate with other managed applications and trusted enterprise resources, thereby creating a virtual partition that is not accessible by unmanaged applications and devices.

The secure applications may be email applications, web browsing applications, software-as-a-service (SaaS) access applications, Windows Application access applications, and the like. The secure applications may be secure native applications 614, secure remote applications 622 executed by a secure application launcher 618, virtualization applications 626 executed by a secure application launcher 618, and the like. The secure native applications 614 may be wrapped by a secure application wrapper 620. The secure application wrapper 620 may include integrated policies that are executed on the mobile device 602 when the secure native application 614 is executed on the mobile device 602. The secure application wrapper 620 may include meta-data that points the secure native application 614 running on the mobile device 602 to the resources hosted at the enterprise (e.g., 604 and 608) that the secure native application 614 may require to complete the task requested upon execution of the secure native application 614. The secure remote applications 622 executed by a secure application launcher 618 may be executed within the secure application launcher 618. The virtualization applications 626 executed by a secure application launcher 618 may utilize resources on the mobile device 602, at the enterprise resources 604, and the like. The resources used on the mobile device 602 by the virtualization applications 626 executed by a secure application launcher 618 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from the enterprise resources 604, and the like. The resources used at the enterprise resources 604 by the virtualization applications 626 executed by a secure application launcher 618 may include user interface generation resources, processing resources, and the like. The user interface generation resources may be used to assemble a user interface, modify a user interface, refresh a user interface, and the like. The processing resources may be used to create information, read information, update information, delete information, and the like. For example, the virtualization application 626 may record user interactions associated with a graphical user interface (GUI) and communicate them to a server application where the server application will use the user interaction data as an input to the application operating on the server. In such an arrangement, an enterprise may elect to maintain the application on the server side as well as data, files, etc. associated with the application. While an enterprise may elect to “mobilize” some applications in accordance with the principles herein by securing them for deployment on the mobile device 602, this arrangement may also be elected for certain applications. For example, while some applications may be secured for use on the mobile device 602, others might not be prepared or appropriate for deployment on the mobile device 602 so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for the mobile device 602 so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data. An enterprise may elect to provide both fully secured and fully functional applications on the mobile device 602 as well as a virtualization application 626 to allow access to applications that are deemed more properly operated on the server side. In an embodiment, the virtualization application 626 may store some data, files, etc. on the mobile device 602 in one of the secure storage locations. An enterprise, for example, may elect to allow certain information to be stored on the mobile device 602 while not permitting other information.

In connection with the virtualization application 626, as described herein, the mobile device 602 may have a virtualization application 626 that is designed to present GUIs and then record user interactions with the GUI. The virtualization application 626 may communicate the user interactions to the server side to be used by the server side application as user interactions with the application. In response, the application on the server side may transmit back to the mobile device 602 a new GUI. For example, the new GUI may be a static page, a dynamic page, an animation, or the like, thereby providing access to remotely located resources.

The secure applications 614 may access data stored in a secure data container 628 in the managed partition 610 of the mobile device 602. The data secured in the secure data container may be accessed by the secure native applications 614, secure remote applications 622 executed by a secure application launcher 618, virtualization applications 626 executed by a secure application launcher 618, and the like. The data stored in the secure data container 628 may include files, databases, and the like. The data stored in the secure data container 628 may include data restricted to a specific secure application 630, shared among secure applications 632, and the like. Data restricted to a secure application may include secure general data 634 and highly secure data 638. Secure general data may use a strong form of encryption such as Advanced Encryption Standard (AES) 128-bit encryption or the like, while highly secure data 638 may use a very strong form of encryption such as AES 256-bit encryption. Data stored in the secure data container 628 may be deleted from the mobile device 602 upon receipt of a command from the device manager 624. The secure applications (e.g., 614, 622, and 626) may have a dual-mode option 640. The dual mode option 640 may present the user with an option to operate the secured application in an unsecured or unmanaged mode. In an unsecured or unmanaged mode, the secure applications may access data stored in an unsecured data container 642 on the unmanaged partition 612 of the mobile device 602. The data stored in an unsecured data container may be personal data 644. The data stored in an unsecured data container 642 may also be accessed by unsecured applications 646 that are running on the unmanaged partition 612 of the mobile device 602. The data stored in an unsecured data container 642 may remain on the mobile device 602 when the data stored in the secure data container 628 is deleted from the mobile device 602. An enterprise may want to delete from the mobile device 602 selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

The mobile device 602 may connect to enterprise resources 604 and enterprise services 608 at an enterprise, to the public Internet 648, and the like. The mobile device 602 may connect to enterprise resources 604 and enterprise services 608 through virtual private network connections. The virtual private network connections, also referred to as microVPN or application-specific VPN, may be specific to particular applications (as illustrated by microVPNs 650, particular devices, particular secured areas on the mobile device (as illustrated by O/S VPN 652), and the like. For example, each of the wrapped applications in the secured area of the mobile device 602 may access enterprise resources through an application specific VPN such that access to the VPN would be granted based on attributes associated with the application, possibly in conjunction with user or device attribute information. The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 654. The single-sign-on processes may allow a user to provide a single set of authentication credentials, which are then verified by an authentication service 658. The authentication service 658 may then grant to the user access to multiple enterprise resources 604, without requiring the user to provide authentication credentials to each individual enterprise resource 604.

The virtual private network connections may be established and managed by an access gateway 660. The access gateway 660 may include performance enhancement features that manage, accelerate, and improve the delivery of enterprise resources 604 to the mobile device 602. The access gateway 660 may also re-route traffic from the mobile device 602 to the public Internet 648, enabling the mobile device 602 to access publicly available and unsecured applications that run on the public Internet 648. The mobile device 602 may connect to the access gateway via a transport network 662. The transport network 662 may use one or more transport protocols and may be a wired network, wireless network, cloud network, local area network, metropolitan area network, wide area network, public network, private network, and the like.

The enterprise resources 604 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. The enterprise resources 604 may be premise-based resources, cloud-based resources, and the like. The enterprise resources 604 may be accessed by the mobile device 602 directly or through the access gateway 660. The enterprise resources 604 may be accessed by the mobile device 602 via the transport network 662.

The enterprise services 608 may include authentication services 658, threat detection services 664, device manager services 624, file sharing services 668, policy manager services 670, social integration services 672, application controller services 674, and the like. Authentication services 658 may include user authentication services, device authentication services, application authentication services, data authentication services, and the like. Authentication services 658 may use certificates. The certificates may be stored on the mobile device 602, by the enterprise resources 604, and the like. The certificates stored on the mobile device 602 may be stored in an encrypted location on the mobile device 602, the certificate may be temporarily stored on the mobile device 602 for use at the time of authentication, and the like. Threat detection services 664 may include intrusion detection services, unauthorized access attempt detection services, and the like. Unauthorized access attempt detection services may include unauthorized attempts to access devices, applications, data, and the like. Device management services 624 may include configuration, provisioning, security, support, monitoring, reporting, and decommissioning services. File sharing services 668 may include file management services, file storage services, file collaboration services, and the like. Policy manager services 670 may include device policy manager services, application policy manager services, data policy manager services, and the like. Social integration services 672 may include contact integration services, collaboration services, integration with social networks such as Facebook, Twitter, and LinkedIn, and the like. Application controller services 674 may include management services, provisioning services, deployment services, assignment services, revocation services, wrapping services, and the like.

The enterprise mobility technical architecture 600 may include an application store 678. The application store 678 may include unwrapped applications 680, pre-wrapped applications 682, and the like. Applications may be populated in the application store 678 from the application controller 674. The application store 678 may be accessed by the mobile device 602 through the access gateway 660, through the public Internet 648, or the like. The application store 678 may be provided with an intuitive and easy to use user interface.

A software development kit 684 may provide a user the capability to secure applications selected by the user by wrapping the application as described previously in this description. An application that has been wrapped using the software development kit 684 may then be made available to the mobile device 602 by populating it in the application store 678 using the application controller 674.

The enterprise mobility technical architecture 600 may include a management and analytics capability 688. The management and analytics capability 688 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

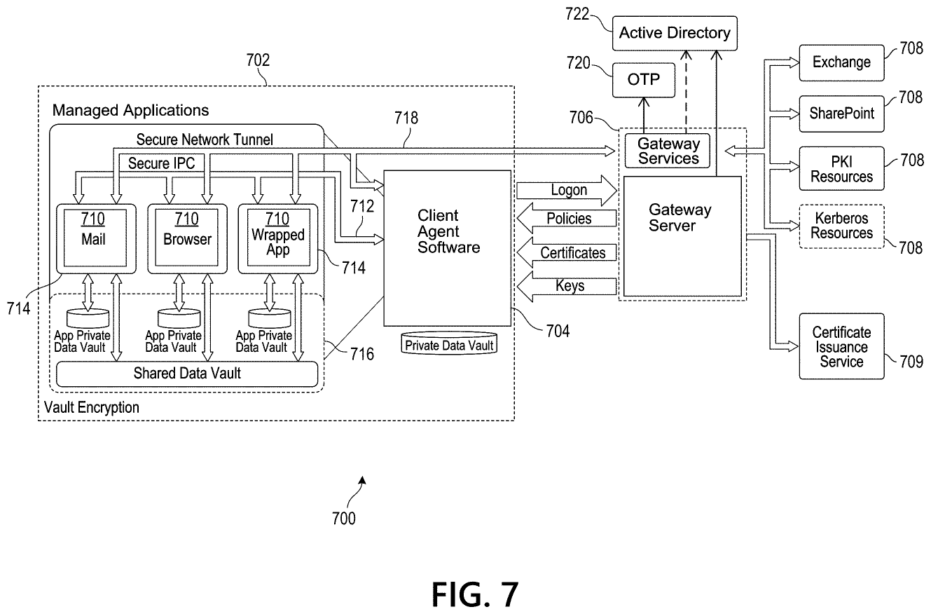

FIG. 7 is another illustrative enterprise mobility management system 700. Some of the components of the mobility management system 600 described above with reference to FIG. 6 have been omitted for the sake of simplicity. The architecture of the system 700 depicted in FIG. 7 is similar in many respects to the architecture of the system 600 described above with reference to FIG. 6 and may include additional features not mentioned above.

In this case, the left hand side represents an enrolled mobile device 702 with a client agent 704, which interacts with gateway server 706 (which includes Access Gateway and application controller functionality) to access various enterprise resources 708 and services 709 such as Exchange, Sharepoint, public-key infrastructure (PKI) Resources, Kerberos Resources, Certificate Issuance service, as shown on the right hand side above. Although not specifically shown, the mobile device 702 may also interact with an enterprise application store (StoreFront) for the selection and downloading of applications.

The client agent 704 acts as the UI (user interface) intermediary for Windows apps/desktops hosted in an Enterprise data center, which are accessed using the High-Definition User Experience (HDX)/ICA display remoting protocol. The client agent 704 also supports the installation and management of native applications on the mobile device 702, such as native iOS or Android applications. For example, the managed applications 710 (mail, browser, wrapped application) shown in the figure above are all native applications that execute locally on the mobile device 702. Client agent 704 and application management framework of this architecture act to provide policy driven management capabilities and features such as connectivity and SSO (single sign on) to enterprise resources/services 708. The client agent 704 handles primary user authentication to the enterprise, normally to Access Gateway (AG) 706 with SSO to other gateway server components. The client agent 704 obtains policies from gateway server 706 to control the behavior of the managed applications 710 on the mobile device 702.

The Secure InterProcess Communication (IPC) links 712 between the native applications 710 and client agent 704 represent a management channel, which may allow a client agent to supply policies to be enforced by the application management framework 714 “wrapping” each application. The IPC channel 712 may also allow client agent 704 to supply credential and authentication information that enables connectivity and SSO to enterprise resources 708. Finally, the IPC channel 712 may allow the application management framework 714 to invoke user interface functions implemented by client agent 704, such as online and offline authentication.

Communications between the client agent 704 and gateway server 706 are essentially an extension of the management channel from the application management framework 714 wrapping each native managed application 710. The application management framework 714 may request policy information from client agent 704, which in turn may request it from gateway server 706. The application management framework 714 may request authentication, and client agent 704 may log into the gateway services part of gateway server 706 (for example, Citrix Gateway). Client agent 704 may also call supporting services on gateway server 706, which may produce input material to derive encryption keys for the local data vaults 716, or may provide client certificates which may enable direct authentication to PKI protected resources, as more fully explained below.

In more detail, the application management framework 714 “wraps” each managed application 710. This may be incorporated via an explicit build step, or via a post-build processing step. The application management framework 714 may “pair” with client agent 704 on first launch of an application 710 to initialize the Secure IPC channel 712 and obtain the policy for that application. The application management framework 714 may enforce relevant portions of the policy that apply locally, such as the client agent login dependencies and some of the containment policies that restrict how local OS services may be used, or how they may interact with the managed application 710.

The application management framework 714 may use services provided by client agent 704 over the Secure IPC channel 712 to facilitate authentication and internal network access. Key management for the private and shared data vaults 716 (containers) may be also managed by appropriate interactions between the managed applications 710 and client agent 704. Vaults 716 may be available only after online authentication, or may be made available after offline authentication if allowed by policy. First use of vaults 716 may require online authentication, and offline access may be limited to at most the policy refresh period before online authentication is again required.

Network access to internal resources may occur directly from individual managed applications 710 through Access Gateway 706. The application management framework 714 may be responsible for orchestrating the network access on behalf of each managed application 710. Client agent 704 may facilitate these network connections by providing suitable time limited secondary credentials obtained following online authentication. Multiple modes of network connection may be used, such as reverse web proxy connections and end-to-end VPN-style tunnels 718.

The Mail and Browser managed applications 710 have special status and may make use of facilities that might not be generally available to arbitrary wrapped applications. For example, the Mail application 710 may use a special background network access mechanism that allows it to access an Exchange server 708 over an extended period of time without requiring a full AG logon. The Browser application 710 may use multiple private data vaults 716 to segregate different kinds of data.

This architecture may support the incorporation of various other security features. For example, gateway server 706 (including its gateway services) in some cases may not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 706 may identify managed native applications 710 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of the data vaults 716 (containers) on the mobile device 702. The vaults 716 may be encrypted so that all on-device data including files, databases, and configurations are protected. For on-line vaults, the keys may be stored on the server (gateway server 706), and for off-line vaults, a local copy of the keys may be protected by a user password or biometric validation. If or when data is stored locally on the mobile device 702 in the secure container 716, it may be preferred that a minimum of AES 256 encryption algorithm be utilized.

Other secure container features may also be implemented. For example, a logging feature may be included, wherein security events happening inside a managed application 710 may be logged and reported to the backend. Data wiping may be supported, such as if or when the managed application 710 detects tampering, associated encryption keys may be written over with random data, leaving no hint on the file system that user data was destroyed. Screenshot protection may be another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on the mobile device 702 is generated using a passphrase or biometric data supplied by the user (if offline access is required). It may be XORed with another key randomly generated and stored on the server side if offline access is not required. Key Derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector will cause multiple copies of the same encrypted data to yield different cipher text output, preventing both replay and cryptanalytic attacks. This will also prevent an attacker from decrypting any data even with a stolen encryption key. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside objective-C instance variables are not stored, as they may be easily referenced. Instead, memory may be manually allocated for these.

An inactivity timeout may be implemented, wherein after a policy-defined period of inactivity, a user session is terminated.

Data leakage from the application management framework 714 may be prevented in other ways. For example, if or when a managed application 710 is put in the background, the memory may be cleared after a predetermined (configurable) time period. When backgrounded, a snapshot may be taken of the last displayed screen of the application to fasten the foregrounding process. The screenshot may contain confidential data and hence should be cleared.

Another security feature may relate to the use of an OTP (one time password) 720 without the use of an AD (active directory) 722 password for access to one or more applications. In some cases, some users do not know (or are not permitted to know) their AD password, so these users may authenticate using an OTP 720 such as by using a hardware OTP system like SecurID (OTPs may be provided by different vendors also, such as Entrust or Gemalto). In some cases, after a user authenticates with a user ID, a text may be sent to the user with an OTP 720. In some cases, this may be implemented only for online use, with a prompt being a single field.

An offline password may be implemented for offline authentication for those managed applications 710 for which offline use is permitted via enterprise policy. For example, an enterprise may want StoreFront to be accessed in this manner. In this case, the client agent 704 may require the user to set a custom offline password and the AD password is not used. Gateway server 706 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 710 as secondary credentials (for the purpose of accessing PKI protected web resources via the application management framework micro VPN feature). For example, a managed application 710 may utilize such a certificate. In this case, certificate-based authentication using ActiveSync protocol may be supported, wherein a certificate from the client agent 704 may be retrieved by gateway server 706 and used in a keychain. Each managed application 710 may have one associated client certificate, identified by a label that is defined in gateway server 706.

Gateway server 706 may interact with an enterprise special purpose web service to support the issuance of client certificates to allow relevant managed applications to authenticate to internal PKI protected resources.

The client agent 704 and the application management framework 714 may be enhanced to support obtaining and using client certificates for authentication to internal PKI protected network resources. More than one certificate may be supported, such as to match various levels of security and/or separation requirements. The certificates may be used by the Mail and Browser managed applications 710, and ultimately by arbitrary wrapped applications 710 (provided those applications use web service style communication patterns where it is reasonable for the application management framework to mediate HTTPS requests).

Application management client certificate support on iOS may rely on importing a public-key cryptography standards (PKCS) 12 BLOB (Binary Large Object) into the iOS keychain in each managed application 710 for each period of use. Application management framework client certificate support may use a HTTPS implementation with private in-memory key storage. The client certificate may not be present in the iOS keychain and may not be persisted except potentially in “online-only” data value that is strongly protected.

Mutual SSL or TLS may also be implemented to provide additional security by requiring that a mobile device 702 is authenticated to the enterprise, and vice versa. Virtual smart cards for authentication to gateway server 706 may also be implemented.

Another feature may relate to application container locking and wiping, which may automatically occur upon jail-break or rooting detections, and occur as a pushed command from administration console, and may include a remote wipe functionality even when a managed application 710 is not running.

A multi-site architecture or configuration of enterprise application store and an application controller may be supported that allows users to be serviced from one of several different locations in case of failure.

In some cases, managed applications 710 may be allowed to access a certificate and private key via an API (for example, OpenSSL). Trusted managed applications 710 of an enterprise may be allowed to perform specific Public Key operations with an application's client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g. transaction log) or for temporary data encryption.

Application Virtualization

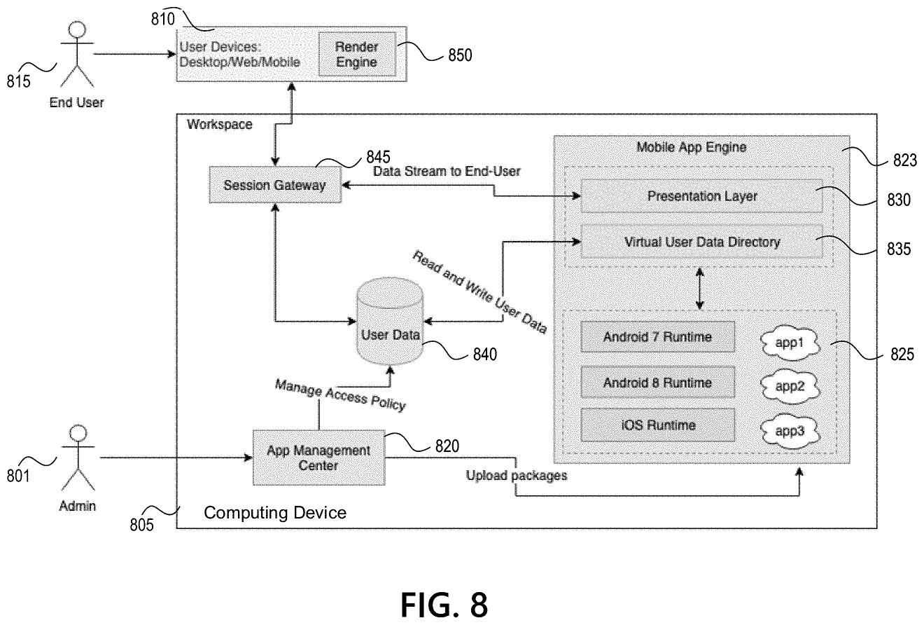

FIG. 8 depicts an illustrative computing environment for enabling the application virtualization in accordance with one or more example embodiments. The system 800 may comprise a computing device 805 (e.g., a remote computing device or server) hosting a plurality of virtual applications. The plurality of virtual applications may be hosted on a workspace. The computing device 805 may include one or more computing devices and/or other computer components (e.g., processors, memories, communication interfaces, servers, server blades, or the like). For example, the computing device 805 may be and/or include any of data server 103 or web server 105 (as depicted in FIG. 1), server 206 (as depicted in FIG. 2), virtualization server 301 (as depicted in FIG. 3), management server 410 (as depicted in FIG. 4), resources management service(s) 502, cloud computing environment 512 (as depicted in FIGS. 5A-5C), or any other computing devices. Virtualized applications can be deployed, initialized, or otherwise accessed on mobile computing devices using interfaces similar to user interface 540 (as depicted in FIG. 5D).

A network administrator 801 may access the computing device 805 via the user interface 540 to upload applications to the application management center 820 in the computing device 805. The applications uploaded may be applications configured to run on a mobile computing device as described in further detail below. The computing device 805 may comprise a mobile application engine 823 configured to deploy instances of the applications and execute these instances deployed. These instances may be executed in runtime environments 825 supported by one or more operating systems. For example, as may be depicted in FIG. 8, the mobile application engine 823 may be hosting Android 7 runtime, Android 8 runtime, and IOS runtime. But any number of runtime environments and any runtime environments supported by any other operating systems are possible.

The computing device 805 may also comprise a user database 840. The user database 840 may store a plurality of user profiles storing information associated with users. The network administrator 801 may, via the application management center 820, upload manage access policies to the user database 840.

A plurality of user devices 810 (e.g., endpoint devices) may communicate with the computing device 805. As may be described in further detail below, if an end-user 815 needs to access an application hosted by the computing device 805, the end-user 815 may instruct the user device 810 to establish a connection with the computing device 805. The user device 810 may communicate with a session gateway 845 in the computing device 805 to establish the connection. The session gateway 845 may send the user device 810 a token (e.g., a session token). For example, the session token may be added into an HTTP header or a TCP/UDP header of a packet, so that the token may be used by the user device 810 to access one or more applications in the computing device 805.

The user device 810 may send information (e.g., the current location of the user device 810) about the user device 810 to the computing device 805. The information may be stored in the user database 840. The user device 810 may also send instructions to execute the applications to the computing device 805. During the execution of the application that the user device 810 accesses, the instructions and information may be retrieved from the user database 840 by the mobile application engine 823 and stored in a cache (e.g., a cache associated with a virtual user data directory 835). A presentation layer 830 of the mobile application engine 823 may be configured to modify the output from execution of the instructions into graphics data. The graphics data may be sent, via the session gateway 845, to a render engine 850 of the user device 810 to enable the user device 810 to render a user interface or an output window associated with the application, so that the end-user 815 may access the application via the user interface or the output window.

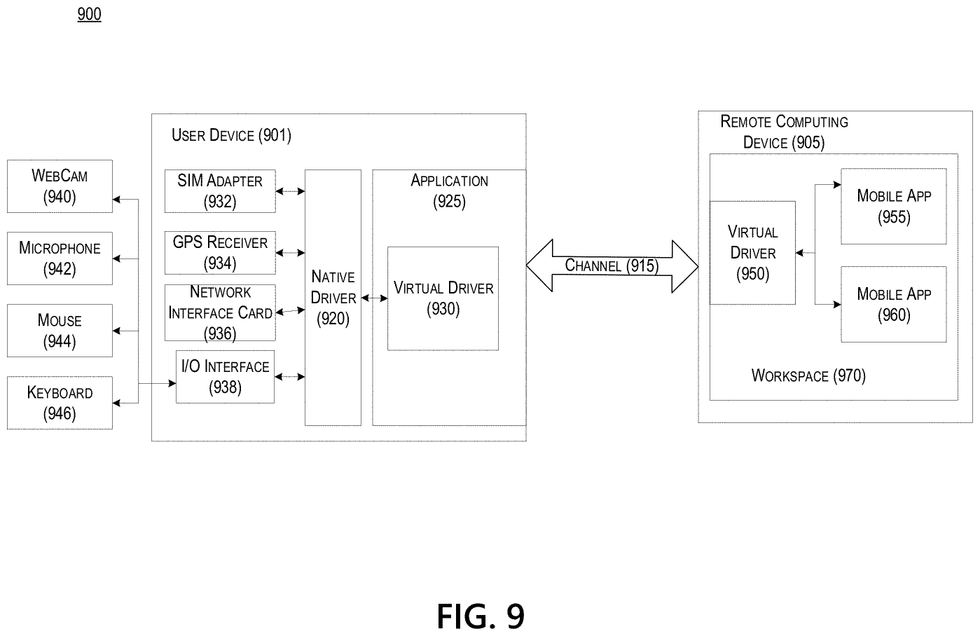

FIG. 9 depicts another illustrative computing environment for enabling the application virtualization in accordance with one or more example embodiments. The system 900 may include one or more computing devices. For example, the system 900 may include a plurality of user devices 901 (e.g., endpoint devices) and a remote computing device 905.

As illustrated in greater detail below, the user device 901 may include one or more computing devices configured to perform one or more of the functions described herein. For example, user device 901 may be a mobile device, a tablet, a smartphone, laptop computer, desktop computer, or the like. For example, in some instances, the user device 901 may be or include any of devices 105, 107, or 109 (as depicted in FIG. 1), client machine 240 (as depicted in FIG. 2), and/or the user device 810 (as depicted in FIG. 8). In some instances, the user device 901 may be configured to expose or otherwise display an interface, and communicate with one or more servers (e.g., via one or more APIs) to update the interface in response to user input received at the user device 901.

As illustrated in greater detail below, remote computing device 905 may be a server that includes one or more computing devices and/or other computer components (e.g., processors, memories, communication interfaces, servers, server blades, or the like). For example, remote computing device 905 may be and/or include any of data server 103 or web server 105 (as depicted in FIG. 1), server 206 (as depicted in FIG. 2), virtualization server 301 (as depicted in FIG. 3), or management server 410 (as depicted in FIG. 4), resources management service(s) 502, cloud computing environment 512 (as depicted in FIGS. 5A-5C) or any other computing devices. The remote computing device 905 may be configured to include componentry similar to that of computing device 805 (as depicted in FIG. 8). In addition, remote computing device 905 may be configured to support application virtualization through the execution of applications that may be displayed or otherwise utilized by the user device 901.

In one or more arrangements, the user device 901, remote computing device 905, and/or the other systems included in the system 900 may be any type of computing device capable of receiving a user interface, receiving input via the user interface, and communicating the received input to one or more other computing devices. For example, user device 901, remote computing device 905, and/or the other systems included in the system 900 may in some instances, be and/or include server computers, desktop computers, laptop computers, tablet computers, smartphones, or the like that may include one or more processors, memories, communication interfaces, storage devices, and/or other components. As noted above, and as illustrated in greater detail below, any and/or all of the user device 901 and/or remote computing device 905 may, in some instances, be special-purpose computing devices configured to perform specific functions.

The system 900 may also include one or more networks, which may interconnect user device 901 and remote computing device 905. For example, the network may be a network depicted in FIGS. 1-8.

If a user wants to access resources on the remote computing device 905 (e.g., an application hosted on a server), the user may communicate with the remote computing device 905 via an application 925 on the user device 901. For example, the user may download a application 925 on the user device 901 and may access the resources on the remote computing device 905 with or otherwise logging in to the application 925. The application 925, in some examples, can be an agent in the form of executable code or scripts configured to establish communications between the devices 901 or 905. In other, more sophisticated examples, application 925 can provide high-performance access to virtual applications and desktops, anywhere access from your desktop start menu, with a user interface (e.g., interface 540) or web access. Examples of such applications include the Citrix® Workspace App.

Registration may be needed prior to the log-in. By registering on the remote computing device 905 via the application 925, the user may be assigned a user identification number and the user may configure or provide information (e.g., password, biometrics authentication information) to access resources hosted on remote computing devices. In some examples, a network administrator may register the user and/or configure access policies for the user (e.g., whether the user has to access certain mobile applications, what pre-requisite network/device environment the user needs to use in order to access certain mobile applications). Other configurations during the registration are also possible.

A session (e.g., web, SAAS, or virtual) may be initiated or otherwise established, for example, with the application 925. Information used during the session may be communicated between the user device 901 and remote computing device 905. For example, the information communicated may comprise the user's access information such as user identifier (or identification number), authentication information (e.g., biometrics, password), and/or the address of the user device. The information may be stored, for example, in a session gateway 845 as depicted in FIG. 8, and be used during the session. For example, if the user wants to access multiple mobile applications, the session gateway 845 may access authentication information in support of the user's access to the multiple mobile applications.

The user device 901 may comprise a native driver 920 configured to communicate with (e.g., receive input and/or send output) native hardware or software components on or associated with the user device 901. For example, the native driver 920 may be configured to communicate with SIM adapter 932, GPS receiver 934, network interface card (NIC) 936, I/O interface 938, and/or other native components. The I/O interface 938 may communicate with I/O devices associated with the user device 901, including but not limited to webcam 940, microphone 942, mouse 944, and keyboard 946. The user may communicate with the user device 901 via these I/O devices.

Multiple applications (e.g., the mobile application 955 and mobile application 960) may be uploaded to the remote computing device 905 in a way as depicted in FIG. 8 above. As described in further details below, if the user device 901 requests to access a mobile application, the remote computing device 905 may deploy an instance of the mobile application. The instance may be deployed on a computing component that provides an operating system to execute the instance. For example, the instance may be deployed on either a physical mobile device within the remote computing device 905 or on a virtual machine (e.g., virtual machine 332 depicted in FIG. 3) that emulates a mobile device.

After the instance is deployed, one or more channels 915 may be established between the user device 901 and the computing component that executes the instance. A virtual address of the computing component or a virtual address of the instance may be assigned and/or communicated to the user device 901. The virtual address may be used when the user device 901 sends/receives packets associated with the application. If more than one channel 915 is established and maintained, any one of the more than one channel 915 may be used to transmit different types of data. For example, one virtual channel 915 may be used to transmit upstream video signals obtained by a webcam 940 associated with the user device 901. For example, another virtual channel 915 may be used to transmit upstream audio signals obtained by a microphone 942 associated with the user device 901. For example, another virtual channel 915 may be used to transmit downstream data regarding the output of the mobile application. Virtual channels 915 configured for other purposes are possible.

A virtual channel 915 may be configured to transmit data associated with a native resource (e.g., a webcam 940, a microphone 942, a mouse 944, or a keyboard 946) on the user device 901. The system 900 (e.g., the user device 901 or the remote computing device 905) may determine that, during a time period, the execution of the instance does not require a first native resource on the user device 901. For example, if the mobile application is an application to hold a conference call, and the user chooses to disable the video function of the mobile application, then the virtual channel 915 associated with the webcam 940 may be disabled. This may be useful to save the bandwidth and/or computing capacity of the system 900.

If the native driver 920 receives instructions and/or input associated with accessing an application on the remote computing device 905, the native driver 920 may send the instructions/input to the virtual driver 930 in the application 925. The virtual driver 930 may encapsulate instructions/inputs based on the protocols agreed with the remote computing device 905, and send the encapsulated packets to the remote computing device 905 via one or more channels 915. A virtual driver 950 on the remote computing device 905 may be configured to receive the packets and translate the packets based on a protocol used by the operating system that hosts the application. As described above, a plurality of runtime environments using a plurality of operating systems may be hosted on the remote computing device 905, and these runtime environments may use different protocols.

If an application that the user device 901 accesses has been executed, the virtual driver 950 on the remote computing device 905 may receive the data associated with the execution, encapsulate the data, and then send the data to the virtual driver 930 on the user device 901. The data may be rendered in a user interface so that the user may be able to further access, via the user interface, the application that is executed on the remote computing device 905.

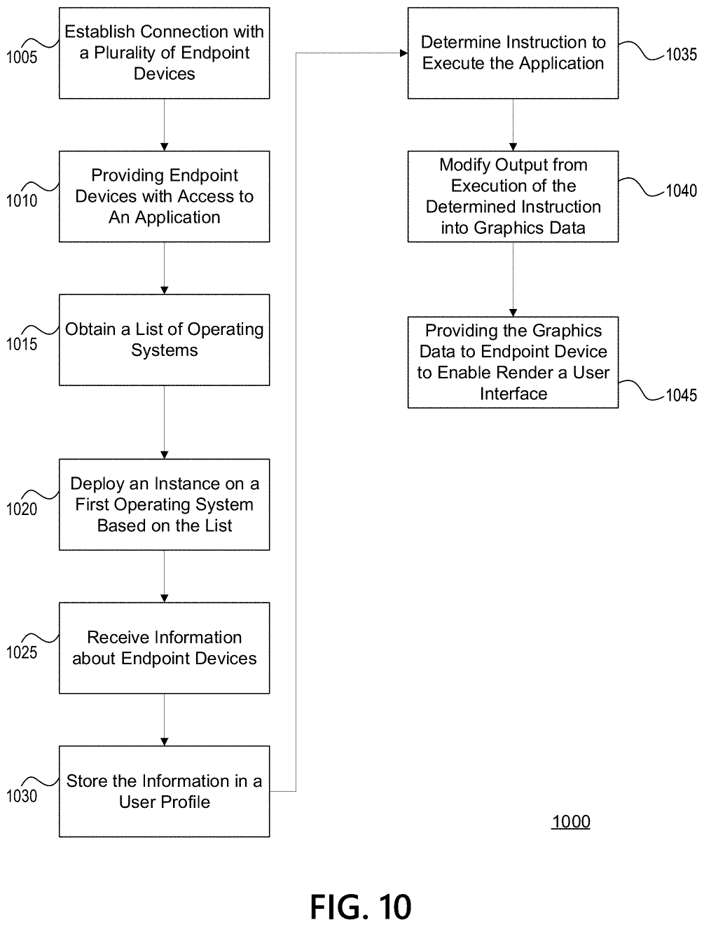

FIG. 10 shows an example of application virtualizations in accordance with one or more example embodiments. Some or all of the steps of method 1000 may be performed using a system (e.g., system 900 depicted in FIG. 5) that comprises one or more computing devices as described herein, including, for example, computing devices depicted in FIGS. 1-9.

At step 1005, a plurality of connections may be established between a plurality of endpoint devices (e.g., user devices 901) and the remote computing device 905 (e.g., a server). For example, the connection between a user device 901 and a remote computing device 905 may be a channel 915 depicted in FIG. 9. A channel 915 (e.g., a virtual channel) may be configured to transmit data (e.g., control packets) between the user device 901 and remote computing device 905. For example, the remote computing device 905 may comprise a control center (e.g., the management server 410 depicted in FIG. 4) that is responsible to send and/or receive control information with user devices 901 and process requests of the user devices 901. For example, processing requests of the user device 901 may comprise deploying application instances based on the user device's 901 request to access the application, as may be described below.

At step 1010, the remote computing device 905 may receive a plurality of requests each associated with accessing an application, configured to run on a mobile device, from an endpoint device (e.g., user device 901). The remote computing device 905 may provide the plurality of endpoint devices with access to the application.

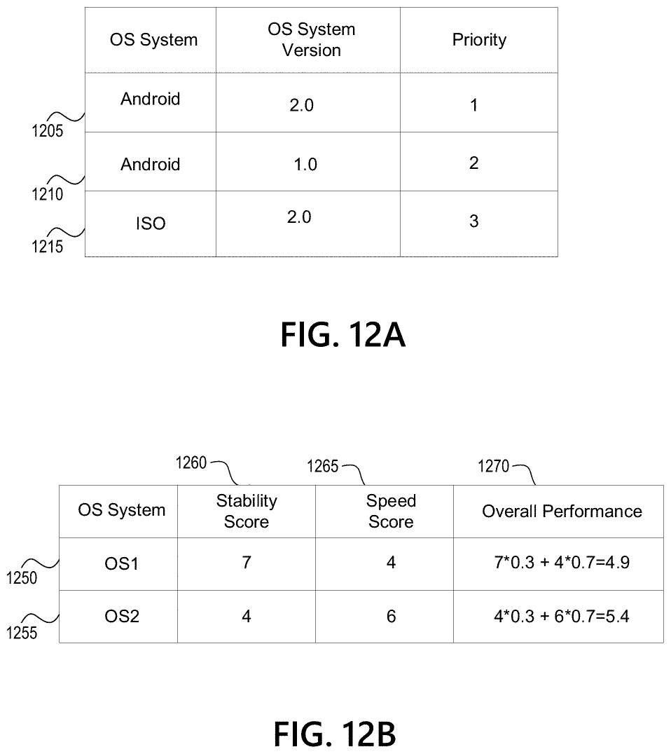

At step 1015, a list or a data table (e.g., preferred list) of operating systems associated with the mobile application may be obtained. The list or data table may comprise at least one operating system (OS) that the application executes. If more than one OS is on the list, a priority associated with individual OSs may be comprised in the list. For example, FIG. 12A depicts an example of a list. The list may comprise multiple OS versions, for example, three OS versions as is shown on FIG. 12A. Other numbers of OS versions are possible. For example, the first row 1205 in the list may indicate that Android system version 2.0 has a priority value of 1, which may indicate the most preferable OS to run the mobile application is Android system version 2.0. The second row 1210 in the list or table may indicate that Android system version 1.0 has a priority value of 2, which may indicate the second-most preferable OS to run the mobile application is Android system version 1.0. The third row 1215 in the list or table may indicate that ISO system version 2.0 has a priority value of 3, which may indicate the third preferable OS to run the mobile application is ISO system version 2.0. Other priority arrangements may be possible.

The list or data table may be generated based on a performance analysis. For example, FIG. 12B may show a performance analysis that may compare the performance of the mobile application when the mobile application is executed on different operating systems. For example, in the example shown in FIG. 12B, the mobile application is executed on OS 1 and OS 2. Multiple performance parameters may be obtained based on the executions. For example, in the example of FIG. 12B, two performance parameters, stability score 1260 and speed score 1265, are provided based on the execution of the mobile application on each OS. For example, a stability score 1260 may indicate how likely the mobile application may crash (e.g., stop functioning properly) during a runtime. For example, a higher score may indicate the mobile application is less likely to crash during runtime on the OS. In the example of FIG. 12B, OS 1 may be associated with a stability score of 7, while OS 2 may be associated with a stability score of 4, which may indicate the mobile application runs more stable on OS 1 than on OS 2. For example, a speed score 1265 may indicate how fast the mobile application responds on average during a runtime. A higher score may indicate the mobile application responds faster. In the example of FIG. 12B, OS 1 may be associated with a speed score of 4, while OS 2 may be associated with a stability score of 6, which may indicate the mobile application runs faster on OS 2 than on OS 1.

For example, if more than one performance parameter is obtained, an overall performance score 1270 may be calculated. For example, individual performance parameters may be assigned a weight, and the overall performance score 1270 may be calculated by weighing individual performance parameters. More weight may be assigned to performance parameters that may be more important to the mobile application. For example, the mobile application may be an online game. Fast data and/or graphics processing may be more important than stability for this application because the processing speed may be more likely to affect the user's experience of this application. Accordingly, more weight (e.g., a weight of 0.7 as is shown in FIG. 12A) may be assigned to the speed score 1265. Less weight (e.g., a weight of 0.3, as is shown in FIG. 12B) may be assigned to the stability score 1260. As may be shown in row 1250, by weighing the parameters, an overall performance score of OS 1 may be 7*0.3+4*0.7=4.9. As may be shown in row 1255, by weighing the parameters, an overall performance score of OS 2 may be 4*0.3+6*0.7=5.4. Based on the overall performance score of OS 2 is superior to the overall performance score of OS1, a preferred list indicating the mobile application is preferred to be executed on OS 2 may be generated.

The list or data table may also be generated by ways other than a performance analysis. For example, a network administrator may configure a list or table based on the network administrator's preference. For example, a user may configure a list or table based on the user's preference. For example, the user may prefer the mobile application to be executed on an OS that system users are familiar with. For example, the list or table may be generated in a way combining the factors discussed above. Other ways to generate the list or table are possible.

Referring back to FIG. 10, at step 1020, an instance associated with a user device 901 may be deployed on a first operating system based on the list. The instance may be deployed on a computing component that provides an operating system to execute the instance. For example, the instance may be deployed on either a physical mobile device or on a virtual machine (e.g., virtual machine 332 depicted in FIG. 3) that emulates a mobile device on the remote computing system 905. For example, the remote computing device 905 may determine whether a computing component running on the most preferred operating system may have spare computing capacities to run an instance, or whether a virtual machine hosted on the most preferred operating system may be created and be used to execute the mobile application. If neither of them works, the next preferable OS may be used.

At step 1025, the remote computing device 905 may receive information about one or more of the endpoint devices (e.g., user devices 901). For example, the information about a user device 901 may comprise a user identifier associated with the user device 901 and one or more parameters associated with the current status of the user device 901. For example, the parameters may comprise the current location, such as a Global Positioning System (GPS) location, of the user device 901. For example, the parameter may comprise the current Internet Protocol (IP) address of the user device 901.

At step 1030, the remote computing device 905 may store a user profile that may comprise the user identifier and the one or more parameters received at step 1025. If the current status of the user device 901 changes during the runtime of the instance, new parameters may be received and updated in the user profile. The user profile may be stored in a user database 840 as depicted in FIG. 8 above.

At step 1035, the remote computing device 905 may determine an instruction to execute the mobile application. For example, the request to execute the mobile device may be received from a user device 901. The remote computing device 905 may determine the instruction based on the request. The execution of the instance associated with the user device 901 may use the information in the user profile.

For example, the mobile application may be an online map and the parameter may be associated with the GPS location of the user device 901. The computing component may use the GPS location of the user device 901 during the execution of the instance.

For example, the mobile application may be a phone call application or a text message application. The execution of the mobile application may require communication with a mobile communication network. For example, the mobile communication network may comprise a Global System for Mobiles (GSM) network, a Code Division Multiple Access (CDMA) network, a 4th-Generation Long-Term Evolution (LTE) network, a 5th-Generation New Radio (NR) network, and/or another type of mobile communication network. The parameter of the current status of the user device 901 may comprise Subscriber Identity Module (SIM) data associated with the user device 901. The SIM data may be used to access the mobile communication network. For example, the SIM data may comprise secure data used to access the mobile communication network, such as to authenticate with the network. The SIM data may comprise, for example, a phone number associated with the SIM and/or the user device 901 (e.g., a Mobile Directory Number (MDN)), an International Mobile Subscriber Identity (IMSI) number which may uniquely identify the SIM and/or user of the SIM on mobile communication networks, an authentication key (e.g., Ki) used to authenticate the SIM on the mobile communication network, and/or other data that may be used to identify and/or authenticate a subscriber of the network. The SIM data may be stored in a physical SIM card inserted into the user device 901, an embedded SIM (eSIM) embedded in the user device 901, and/or a software SIM stored in the memory of the user device 901.

As may be described above, during the time when the instance is executed, the system 900 may register the computing component, that executes the instance, with the mobile communication network. The computing component may receive packets (e.g., text messages, voice signals) from the user device 901 via one or more virtual channels 915. The computing component may process the packets as the mobile application ordinarily does, and then forward these processed packets to a network node in the mobile communication network. Similarly, when receiving packets from the mobile communication network associated with the SIM data, the computing component may process the packets by executing the mobile application and then send the packets to the user device 901, via one or more virtual channels 915.

This may be useful if the user device 901 is outside the service area of the mobile communication network. For example, the service area of the mobile communication network covers a geographical area of a country, but the user device 901 is outside the country. For example, the remote computing device 905 may deploy an instance on a computing component that is within the service area of the mobile communication network (e.g., inside the country). The computing component may execute the instance as described above.

At step 1040, the system (e.g., the remote computing device 905) may modify output from execution of the determined instruction into graphics data. The output of the execution of the determined instruction may be encapsulated into graphics data based on a presentation layer protocol (e.g., a remote presentation protocol as may be described in FIG. 2 above). The graphics data may be used to enable the user device 810 to render a user interface in which to access the application.

At step 1045, the graphics data may be provided to one or more endpoint devices (e.g., user devices 901) to enable render a user interface in which to access the application. For example, the graphics data may be sent via one or more channels 915 as described above. Each of the one or more user devices 901 may decapsulate the packets and display them in an output window (e.g., an application window) on a user interface.

One or more steps of the example, the method may be rearranged, omitted, and/or otherwise modified, and/or other steps may be added.

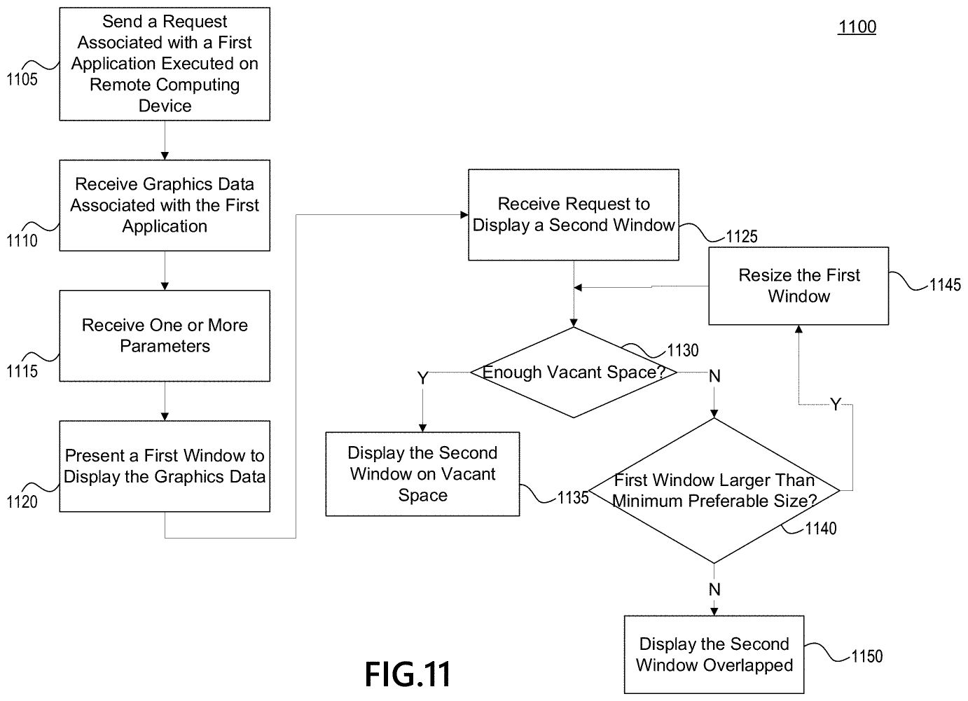

FIG. 11 shows an example of application virtualization in accordance with one or more example embodiments. Some or all of the steps of method 1100 may be performed using a system 900 that may comprise one or more computing devices as described herein, including, for example, computing devices depicted in FIGS. 1-9. The method 1100 may be used in connection with FIG. 10.

At step 1105, a user device 901 may send a request associated with a first application, being hosted by a server (e.g., the remote computing device 905) and configured to run on a mobile computing device. The request may comprise an identification of the first application and may indicate a request to access the first application or user input to interact with the first application. For example, the user device 901 and the remote computing device 905 may have established a connection, e.g., a channel 915, as may be described at step 1005. The first mobile application may be stored on the remote computing device 905. For example, the request may be similar to the request described in step 1010. After receiving the request, the remote computing device 905 may process the request by deploying an instance and execute the instance, as may be described in FIG. 10 above.

At step 1110, the user device 901 may receive data (e.g., graphics data) associated with the first mobile application. For example, the data may be received as one or more packets encapsulated according to a presentation layer protocol (e.g., a remote presentation protocol described in FIG. 2). For example, the data may be graphics data such as described in step FIG. 10.

At step 1115, the user device 901 may receive one or more parameters (e.g., preferred display parameters) of the first mobile application. The parameters may comprise attributes or characteristics regarding the display of the data. For example, the parameters may comprise one or more of a preferred size (e.g., a preferred length and/or width), a preferred resolution, a preferred length-width ratio, or a preferred orientation. The parameters may comprise a value or a range of values. For example, a preferred length-width ratio may be a value of 4:3. For example, a preferred length may be a range of “equal or more than 400 pixels.” For example, the parameters may be configured by the network administrator or may be configured by the developer of the mobile application. Other parameters and/or other ways to configure the preferred display parameters are possible.

At step 1120, the user device 901 may present, on a graphical user interface and based on the parameters, a first output window to display the graphic data associated with the first mobile application.

For example, if a parameter is an orientation, the parameter value may be “portrait.” Based on the parameter, the user device 901 may display a portrait window. This may be particularly useful if the user device 901 is a desktop computer or a laptop, since many desktop computers or laptops may be associated with a screen monitor having a landscape orientation, while the mobile application may be designed to be presented on a mobile device (e.g., a mobile phone) having a portrait screen.

The first output window may also be displayed based on a combination of the parameters, the settings of the user device 901, and/or the current status of the user device 901. For example, if the parameter is a minimum preferred size (e.g., the preferred length is no less than 400 pixels, and the preferred width may be no less than 300 pixels). The user device's 901 settings may indicate output windows should be displayed as large as possible if there is enough vacant space. For example, based on the combination of the user device's 901 settings, the minimum preferred size, and a current status that no other windows are currently displayed in the graphical user interface, the user device 901 may determine that the first output window may be displayed using the entire graphical user interface.

After the first output window is displayed, the user may interact with the mobile application by making a user input command. The user device 901 may determine that the user input command is associated with the first mobile application. For example, if the user input command is made when the mouse cursor is on the first output window, it may be determined that the user input command is associated with the first mobile application. Then, a determination may be made as to whether the user input command is a command that may be used to interact with a desktop computing device, for example, whether the user input command comprises either one of a mouse input command, keyboard shortcut command, or trackpad command. If so, the system 900 may translate the user input command into a second command that may be readable by a mobile device, so that it may be used to execute the instance of the mobile application. For example, a left-click command made by a mouse may be translated into a finger tap command readable by a mobile device. For example, a left press-move-release command made by a mouse may be translated as a swipe command readable by a mobile device. For example, a right press-movement-release command made by a mouse may be translated into a gesture to unlock the screen on a mobile device. For example, a trackpad two-finger-scroll command may be translated into a one-finger-scroll readable by a mobile device. For example, certain shortcut keyboard commands may be translated into the corresponding finger swipes readable by a mobile device. Other translations are possible. These translated commands may be sent to the remote computing device 905, for example, via a virtual channel 915 to command the execution of the instance of the mobile application.

At step 1125, the user device 901 may receive another request to display a second output window. For example, the second output window may be used to display the output of a second mobile application that is executed on the remote computing device 905 in a similar way such as described above in FIG. 10 and FIG. 11. For another example, the second output window may be used to display the data (e.g., graphics data) of another application executed on the user device 901 locally. For another example, the second output window may also be used to display the data of other applications executed on other computing devices.

At step 1130, the user device 901 may determine whether or not enough vacant space is left on the graphical user interface to display the second output window. For example, a vacant space may be available on the graphical user interface if the first output window is displayed using only a portion of the graphical user interface. For example, if the preferred orientation of the first output window is a portrait while the graphical user interface is a landscape, the first output window may be displayed using only a portion of the graphical user interface.

Vacant space may be determined to be enough based on a minimum preferred size of the second mobile application. For example, if the vacant space on the graphical user interface is larger than the minimum preferred size, then it may be determined that there is enough vacant space. For example, the minimum preferred size may be a size to display the data (e.g., graphics data) of the mobile application without having certain content items in the output window being obscured to an unaccepted level. This may be useful particularly if the user device 901 is a desktop computer or laptop that may be associated with a larger screen, while the first/second mobile application may be designed to be displayed on a mobile device that may have a smaller screen. The developer of the mobile application may design the layout of the output window containing less and/or simpler content items than a corresponding desktop application's window may contain. Therefore, the output window of a mobile application may be displayed using a space less than the entire screen of a desktop computer and yet without certain items being obscured.

If it is determined that there is enough vacant space to display the second output window, then the method may proceed to step 1135. At step 1135, the second output window may be displayed on the vacant space. For example, the first output window may be displayed on a first portion of the graphical user interface and the second output window may be displayed on a second portion of the graphical user interface.

If it is determined that there is not enough vacant space to display the second output window, then the method may proceed to step 1140. At step 1140, a determination may be made as to whether the first output window is currently displayed at a size larger than the minimum preferable size. For example, if the minimum preferable size is 400*300 pixels, while the first output window is currently displayed at 1600*1200 pixels, then it may be determined that the first output window is currently displayed at a size larger than the minimum preferable size. Then, the method may proceed to step 1145.

At step 1145, the first output window may be resized based on the minimum preferred display size. For example, the first output window may be resized to the minimum preferred display size. For another example, the first output window may be resized to a size so that enough vacant space is created to display the second output window. After the first output window is resized, the method may return back to step 1130.

Referring back to the determination at step 1140, if it is determined that the first output window is currently displayed at a size no larger than the minimum preferable size, then the method may proceed to step 1150. At step 1150, the second output window may be displayed partially or entirely overlapped with at least another window, for example, the first output window.

One or more steps of the example, the method may be rearranged, omitted, and/or otherwise modified, and/or other steps may be added.

The following paragraphs (M1) through (M15) describe examples of methods that may be implemented in accordance with the present disclosure.

(M1) A method comprising providing, by a computing device, a plurality of endpoint devices with access to an application, the application being hosted by the computing device and configured to run on a mobile computing device; determining, by the computing device, instructions to execute the application for different endpoint devices of the plurality based on information about the plurality of endpoint devices; modifying, by the computing device, output from execution of the determined instructions into graphics data; and providing, by the computing device, the graphics data to at least one of the plurality of endpoint devices to enable that endpoint device to render a user interface in which to access the application.

(M2) A method may be performed as described in paragraph (M1) wherein the information about the plurality of endpoint devices comprises at least one of: current location of the different endpoint devices of the plurality; or current Internet Protocol (IP) address of the different endpoint devices of the plurality.

(M3) A method may be performed as described in paragraph (M1) through (M2) further comprising: obtaining a preferred list that indicates the application is preferred to be executed on a first operating system; and deploying, based on the preferred list, a plurality of instances on a computing component running on the first operating system to execute of the application.

(M4) A method may be performed as described in paragraph (M3) wherein the computing component is a virtual machine, wherein deploying the one or more instances on a computing component further comprises: creating, based on the preferred list, the virtual machine; and deploying the one or more instances on the virtual machine.

(M5) A method may be performed as described in any of paragraphs (M3) through (M4) further comprising obtaining a first performance parameter associated with executing the application on the first operating system; obtaining a second performance parameter associated with executing the application on a second operating system; and generating, based on the first performance parameter is superior to the second performance parameter, the preferred list.

(M6) A method may be performed as described in paragraph (M5) wherein the first performance parameter comprises: stability associated with the execution of the application; or speed associated with the execution of the application.

(M7) A method may be performed as described in any of paragraphs (M3) through (M6) further comprising: assigning, to the computing component, a virtual address; and establishing, using the virtual address, a plurality of channels between the plurality of endpoint devices and the computing component.

(M8) A method may be performed as described in paragraph (M7) wherein the plurality of channels comprise a first channel configured to transmit data associated with a native resource on a first endpoint device of the plurality, the method further comprises: determining an execution of a first instance of the plurality of instances, during a time period, does not require accessing the native resource; and disabling, based on the determination, the first channel.

(M9) A method may be performed as described in any of paragraphs (M1) through (M8), wherein the information about the plurality of endpoint devices comprises a subscriber identification module (SIM) data associated with a first endpoint device of the plurality, wherein an execution of the application requires access to a mobile communication network, wherein the SIM data is used to access the mobile communication network.

(M10) A method may be performed as described in paragraph (M9), wherein the first endpoint device is in a geographical location outside a service area of the mobile communication network, the method further comprises: deploying an instance on a first computing component within the service area of the mobile communication network; and communicating, by the first computing component and using the SIM data, with the mobile communication network.

(M11) A method comprising: sending, from a desktop computing device and to a server, a request associated with a first application being hosted by the server and configured to run on a mobile computing device; receiving graphics data associated with the first application; receiving a preferred display parameter associated with the first application; presenting, on a graphical user interface and based on the preferred display parameter, a first output window, wherein the graphics data is displayed in the first output window; determining, a vacant space on the graphical user interface; and presenting, on the graphical user interface, a second output window associated with a second application.

(M12) A method may be performed as described in paragraph (M11), wherein a preferred display parameter comprises a minimum preferred size, the method further comprises: receiving, a command to present a third output window; determining the minimum preferred size is smaller than a current size of the first output window; resizing, based on the determination, the first output window; and displaying the first output window on a first portion of the graphical user interface and the third output window on a second portion of the graphical user interface.

(M13) A method may be performed as described in any of paragraphs (M11) through (M12), wherein the graphical user interface is a landscape orientation, and wherein the preferred display parameter comprises a portrait orientation.

(M14) A method may be performed as described in any of paragraphs (M11) through (M13), further comprising establishing one or more channels between the desktop computing device and the server.

(M15) A method may be performed as described in any of paragraphs (M11) through (M14), wherein the one or more channels comprise a first channel configured to transmit data associated with a native resource on the desktop computing device, the method further comprises: determining execution of the first application does not require, during a time period, the native resource; and disabling, based on the determination, the first channel.

The following paragraphs (A1) through (A5) describe examples of apparatuses that may be implemented in accordance with the present disclosure.

(A1) An computing device comprising at least one processor; memory configured to store computer-readable instructions that, when executed by the at least one processor, cause the computing device to perform actions comprising: providing a plurality of endpoint devices with access to an application, the application being hosted by the computing device and configured to run on a mobile computing device; determining instructions to execute the application for different endpoint devices of the plurality based on information about the plurality of endpoint devices; modifying output from execution of the determined instructions into graphics data; and providing the graphics data to at least one of the plurality of endpoint devices to enable that endpoint device to render a user interface in which to access the application.

(A2) A computing device may be performed as described in paragraph (A1), wherein the information about the plurality of endpoint devices comprises at least one of: current location of the different endpoint devices of the plurality; or current Internet Protocol (IP) address of the different endpoint devices of the plurality.

(A3) A computing device may be performed as described in any of the paragraphs (A1) through (A2), wherein the computer-readable instructions are further configured to cause the computing device to perform actions comprising: obtaining a preferred list that indicates the application is preferred to be executed on a first operating system; and deploying, based on the preferred list, a plurality of instances on a computing component running on the first operating system to execute of the application.

(A4) A computing device may be performed as described in paragraph (A3), wherein the computing component is a virtual machine, wherein the computer-readable instructions are configured to cause the computing device to deploy one or more instances on a computing component by performing actions comprising: creating, based on the preferred list, the virtual machine; and deploying the one or more instances on the virtual machine.

(A5) A computing device may be performed as described in any of the paragraphs (A3) through (A4), wherein the computer-readable instructions are further configured to cause the computing device to perform actions comprising: obtaining a first performance parameter associated with executing the application on the first operating system; obtaining a second performance parameter associated with executing the application on a second operating system; and generating, based on the first performance parameter is superior to the second performance parameter, the preferred list.

The following paragraph (CRM1) describe examples of computer-readable media that may be implemented in accordance with the present disclosure.

(CRM1) A non-transitory computer-readable medium storing instructions that, when executed, cause a system to perform: providing, by a computing device, a plurality of endpoint devices with access to an application, the application being hosted by the computing device and configured to run on a mobile computing device; determining, by the computing device, instructions to execute the application for different endpoint devices of the plurality based on information about the plurality of endpoint devices; modifying, by the computing device, output from execution of the determined instructions into graphics data; and providing, by the computing device, the graphics data to at least one of the plurality of endpoint devices to enable that endpoint device to render a user interface in which to access the application.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method, comprising:
providing, by a computing device, a plurality of endpoint devices with access to an application, the application being hosted by the computing device and configured to run on a mobile computing device;
determining, by the computing device, instructions to execute the application for different endpoint devices of the plurality based on information about the plurality of endpoint devices;
modifying, by the computing device, output from execution of the determined instructions into graphics data; and
providing, by the computing device, the graphics data to at least one of the plurality of endpoint devices to enable that endpoint device to render a user interface in which to access the application.

2. The method of claim 1, wherein the information about the plurality of endpoint devices comprises at least one of:
current location of the different endpoint devices of the plurality; or
current Internet Protocol (IP) address of the different endpoint devices of the plurality.

3. The method of claim 1, further comprising:
obtaining a preferred list that indicates the application is preferred to be executed on a first operating system; and
deploying, based on the preferred list, a plurality of instances on a computing component running on the first operating system to execute of the application.

4. The method of claim 3, wherein the computing component is a virtual machine, wherein deploying the one or more instances on a computing component further comprises:
creating, based on the preferred list, the virtual machine; and
deploying the one or more instances on the virtual machine.

5. The method of claim 3, further comprising:
obtaining a first performance parameter associated with executing the application on the first operating system;
obtaining a second performance parameter associated with executing the application on a second operating system; and
generating, based on the first performance parameter is superior to the second performance parameter, the preferred list.

6. The method of claim 5, wherein the first performance parameter comprises:
stability associated with the execution of the application; or
speed associated with the execution of the application.

7. The method of claim 3, further comprises:
assigning, to the computing component, a virtual address; and
establishing, using the virtual address, a plurality of channels between the plurality of endpoint devices and the computing component.

8. The method of claim 7, wherein the plurality of channels comprise a first channel configured to transmit data associated with a native resource on a first endpoint device of the plurality, the method further comprises:
determining an execution of a first instance of the plurality of instances, during a time period, does not require accessing the native resource; and
disabling, based on the determination, the first channel.

9. The method of claim 1, wherein the information about the plurality of endpoint devices comprises a subscriber identification module (SIM) data associated with a first endpoint device of the plurality, wherein an execution of the application requires access to a mobile communication network, wherein the SIM data is used to access the mobile communication network.

10. The method of claim 9, wherein the first endpoint device is in a geographical location outside a service area of the mobile communication network, the method further comprises:
deploying an instance on a first computing component within the service area of the mobile communication network; and
communicating, by the first computing component and using the SIM data, with the mobile communication network.

11. A method, comprising:
sending, from a desktop computing device and to a server, a request associated with a first application being hosted by the server and configured to run on a mobile computing device;
receiving graphics data associated with the first application;
receiving a preferred display parameter associated with the first application;
presenting, on a graphical user interface and based on the preferred display parameter, a first output window, wherein the graphics data is displayed in the first output window;
determining, a vacant space on the graphical user interface; and
presenting, on the graphical user interface, a second output window associated with a second application.

12. The method of claim 11, wherein a preferred display parameter comprises a minimum preferred size, the method further comprises:
receiving, a command to present a third output window;
determining the minimum preferred size is smaller than a current size of the first output window;
resizing, based on the determination, the first output window; and
displaying the first output window on a first portion of the graphical user interface and the third output window on a second portion of the graphical user interface.

13. The method of claim 11, wherein the graphical user interface is a landscape orientation, and wherein the preferred display parameter comprises a portrait orientation.

14. The method of claim 11, further comprising establishing one or more channels between the desktop computing device and the server.

15. The method of claim 11, wherein the one or more channels comprise a first channel configured to transmit data associated with a native resource on the desktop computing device, the method further comprises:
determining execution of the first application does not require, during a time period, the native resource; and
disabling, based on the determination, the first channel.

16. A computing device, comprising:
at least one processor;
memory configured to store computer-readable instructions that, when executed by the at least one processor, cause the computing device to perform actions comprising:
providing a plurality of endpoint devices with access to an application, the application being hosted by the computing device and configured to run on a mobile computing device;
determining instructions to execute the application for different endpoint devices of the plurality based on information about the plurality of endpoint devices;
modifying output from execution of the determined instructions into graphics data; and
providing the graphics data to at least one of the plurality of endpoint devices to enable that endpoint device to render a user interface in which to access the application.

17. The computing device of claim 16, wherein the information about the plurality of endpoint devices comprises at least one of:
current location of the different endpoint devices of the plurality; or
current Internet Protocol (IP) address of the different endpoint devices of the plurality.

18. The computing device of claim 16, wherein the computer-readable instructions are further configured to cause the computing device to perform actions comprising:
obtaining a preferred list that indicates the application is preferred to be executed on a first operating system; and
deploying, based on the preferred list, a plurality of instances on a computing component running on the first operating system to execute of the application.

19. The computing device of claim 18, wherein the computing component is a virtual machine, wherein the computer-readable instructions are configured to cause the computing device to deploy one or more instances on a computing component by performing actions comprising:
creating, based on the preferred list, the virtual machine; and
deploying the one or more instances on the virtual machine.

20. The computing device of claim 18, wherein the computer-readable instructions are further configured to cause the computing device to perform actions comprising:
obtaining a first performance parameter associated with executing the application on the first operating system;
obtaining a second performance parameter associated with executing the application on a second operating system; and
generating, based on the first performance parameter is superior to the second performance parameter, the preferred list.
